(19) United States
(12) Patent Application Publication
(10) Pub. No.: US 2019/0007098 A1
(43) Pub. Date: Jan. 3, 2019

(54) LIVE ELECTRICAL POWERLINE SIMULATION SYSTEM

(71) Applicant: Hydro Ottawa Holding Inc., Ottawa (CA)

(72) Inventors: Derek BOASE, Ottawa (CA); Bradley KASABOSKI, Ottawa (CA); Mauricio LEDON, Ottawa (CA)

(21) Appl. No.: 15/681,666

(22) Filed: Aug. 21, 2017

Related U.S. Application Data
(60) Provisional application No. 62/527,325, filed on Jun. 30, 2017.

(51) Int. Cl. H04B 3/54; H02J 13/00; H02J 3/00

(52) U.S. Cl. CPC H04B 3/54; H02J 13/0024; H04B 2203/5495; H04B 2203/5458; H02J 3/00

(57) ABSTRACT

A powerline simulation system is provided that is used in facilitating the powerline technician training to simulate powerline contact without using a live powerline. A conductive mesh liner covers an exterior of a torso and arms of an electrical safety jacket worn by a powerline technician or trainee. A controller coupled to the mesh detects contact of the mesh with an un-energized electrical line, the contact is detected through a change in capacitance of the mesh and providing an audible indication of the contact to the powerline technician or trainee. The simulation tool allows a consistent testing environment, ensuring that no touches are missed.

### CROSS-REFERENCE TO RELATED APPLICATIONS

This application claims priority from U.S. Provisional Application No. 62/527,325 filed Jun. 30, 2017 the entirety of which is hereby incorporated by reference in its entirety for all purposes.

### TECHNICAL FIELD

The present disclosure relates to electrical powerline distribution and in particular to a system and method for training powerline technicians.

### BACKGROUND

The current training and testing process for powerline technicians requires an instructor to supervise powerline technicians while working on simulated energized electrical powerlines and identifying when inadvertent contact occurs with the simulated powerline. Powerline technician trainees are required to exhibit the skills to work with high-voltage lines, however relying on visual identification of contacts with a powerline does not always provide the necessary feedback to ensure safe working practices when eventually working with energized lines. Using visual feedback alone makes it challenging for the supervisor or instructor to determine whether or not a powerline technician is actually touching the un-energized line particularly when overhead, which may be approximately 40 to 50 feet high. Accordingly, improved systems and methods for the training of powerline technicians remains highly desirable.

### BRIEF DESCRIPTION OF THE DRAWINGS

Further features and advantages of the present invention will become apparent from the following detailed description, taken in combination with the appended drawings, in which:

FIG. 1 shows a representation of a powerline technician working on a powerline from an insulated aerial device;

FIG. 2 shows a representation of a powerline technician working off of a pole;

FIG. 3 shows a representation of an electrical safety jacket providing an electrical powerline simulation system;

FIG. 4 shows a system representation of the electrical powerline simulation system;

FIG. 5 shows a method of operation of an electrical powerline simulation system; and

FIG. 6 shows a method of calibrating an electrical powerline simulation system.

It will be noted that throughout the appended drawings, like features are identified by like reference numerals.

### DETAILED DESCRIPTION

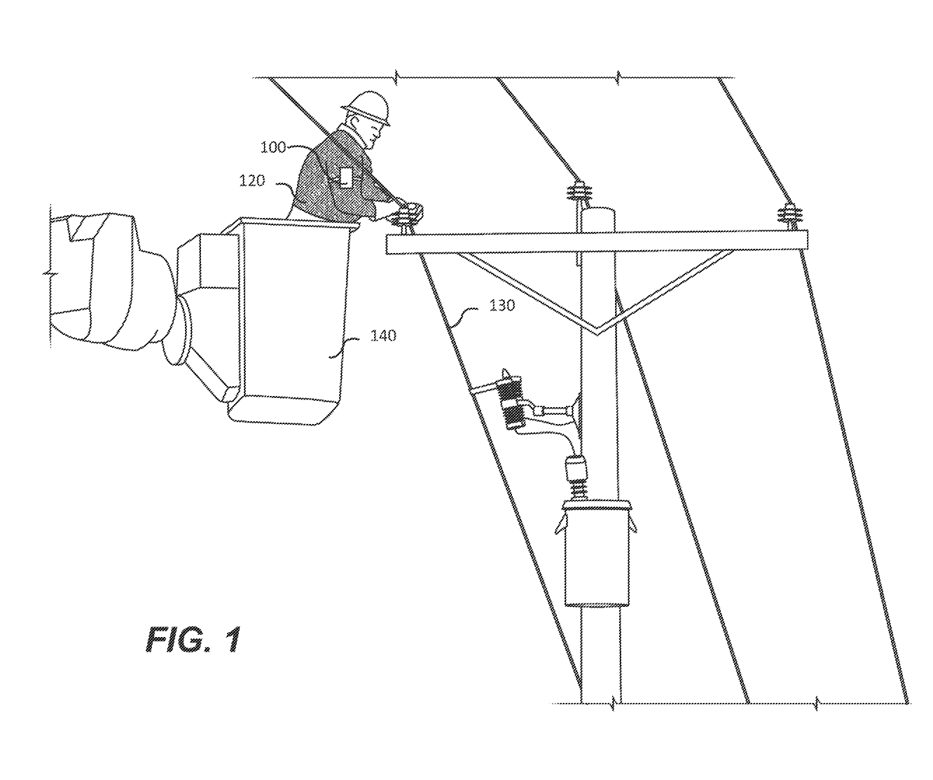

Embodiments are described below, by way of example only, with reference to FIGS. 1-6.

In accordance with an aspect of the present disclosure there is provided A live electrical line simulation system comprising: a conductive mesh liner for covering an exterior of a torso and arms of an electrical safety jacket worn by a powerline technician or trainee; and a controller coupled to the mesh for detecting contact of the mesh with an un-energized electrical line, the contact detected through a change in capacitance of the mesh and providing an audible indication of the contact to the powerline technician or trainee.

In accordance with another aspect of the present disclosure there is provided a method of live electrical line simulation system, the method comprising: detecting a higher capacitance threshold at a controller coupled to a conductive mesh liner covering an electrical safety jacket, when the conductive mesh is in contact with an object; detecting a lower capacitance threshold at the controller when the conductive mesh is not contacting the object; detecting by the controller when a determined capacitance is above the higher capacitance threshold; and generating an alert while the determined capacitance is above the higher capacitance threshold and terminating the alert when the determined capacitance is at a lower capacitance threshold.

In accordance with yet another aspect of the present disclosure there is provided an electrical line safety jacket comprising: a conductive mesh on the exterior of the safety jacket on a torso and arms of an electrical safety jacket worn by a powerline technician or trainee; and a controller coupled to the mesh for detecting contact of the mesh with an un-energized electrical line, the contact detected through a change in capacitance of the mesh and providing an audible indication of the contact to the powerline technician or trainee.

The powerline simulation system is used in facilitating the powerline technician training to simulate powerline contact without using a live powerline. The benefits to the training procedure is that the process is standardized, regulating the testing process and facilitating the supervisor's or instructor's ability to accurately detect when a powerline technician makes contact. The current training and testing process is limited in the sense that the ratio of technicians to supervisors, for example a ratio of 6:1, makes it challenging for the supervisor or instructor to determine whether or not a powerline technician is actually touching the un-energized lines. During the examination process, this simulation tool allows a consistent testing environment, ensuring that no touches are missed. The objective of the live electrical line simulation system is to provide an improved system and method to enable a standardized and consistent training process.

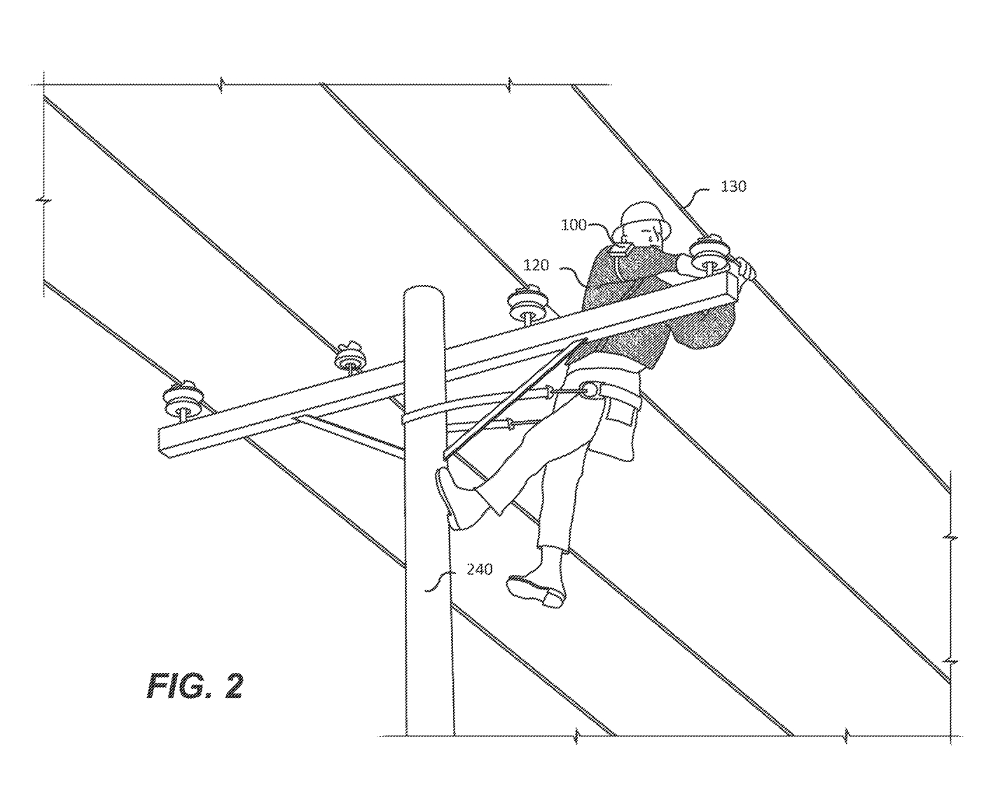

As shown in FIGS. 1 and 2, the live powerline simulation system 100 provides an audible and/or a visual alert if the technician 120 touches a metal element, for example the power line 130 or a metallic portion. In this example, the technician 120 is on a platform of an insulated aerial device 140 or working off of a pole 240 using spurs. The live powerline simulation system 100 provides a lightweight and flexible design that does not limit the movement of the powerline technician, enabling a realistic environment for testing the required skills. The powerline simulation system 100 detects a change in capacitance of a conductive fabric or mesh liner worn by the powerline technician. The system 100 automatically calibrates with every use to avoid false readings and allows for a more thorough and standardized practice environment. The testing line 130 is typically comprised of 6 strands of aluminum wire, surrounding a single strand of steel, and typically have a run of over 100 meters, approximately 300 feet. The capacitance of the line is much larger than the capacitance of the electrical line simulation system.

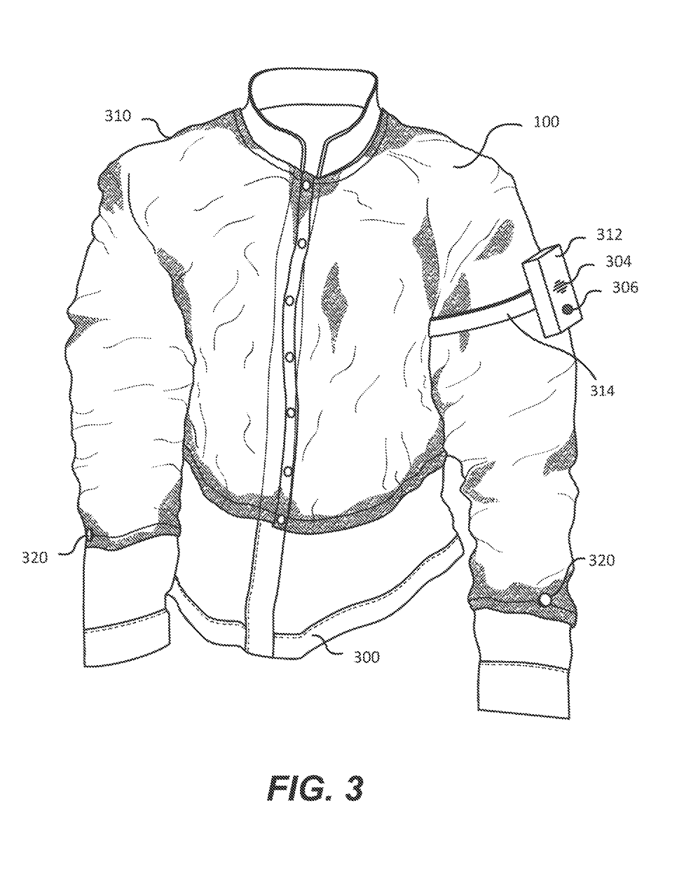

Referring to FIG. 3, an electrical safety jacket 300, as would be typically worn by powerline technicians, is used with the live powerline simulation system 100. A conductive mesh 310 covers the electrical safety jacket 300 which is coupled with a controller 312 which generates alerts when contact occurs. The live powerline simulation system 100 uses a capacitive sensor from the controller 312 to measure the capacitance value of the mesh 310, in milliseconds, that it takes for the receive pin to match the Boolean state of the send pin of the controller. The mesh 310 is a conductive woven material such as, but not limited to, a copper, nickel/copper, silver plated, or copper-tin mesh etc. which is flexible and does not restrict movement of the operator. The controller 312 has a conductive contact with the mesh 310. The controller 312 can be directly attached to an exterior copper-tin mesh that surrounds the jacket 300 and provides a fully mobile live powerline simulation system. The sensor of the controller 312, which is attached to the mesh 310, detects the change in capacitance that is added when in contact with the wire 130 or other conductive objects. Once the change in capacitance is detected, an audible alert can be generated, for example through a piezo sounder 304, or a visual indicator 306 such as an LED, which will alert the supervisor or instructor. The mesh 310 covers the arms and torso of the jacket 300 and may be attached by snaps 320, Velcro™ or clips to the jacket 300. The controller 312 can be secured by a strap, clip or a pocket to the mesh 310 or the jacket 300. The controller 312 can be placed on an arm or torso of the jacket 300. If the controller 312 is placed on the mesh 310, the back surface of the controller can be conductive and coupled to the sensor providing a large contact plane. Alternatively, a lead or connecting wire may be used to couple the controller to the mesh 310. The conductive mesh 310 may alternatively be incorporated into a jacket or garment worn by the powerline technician.

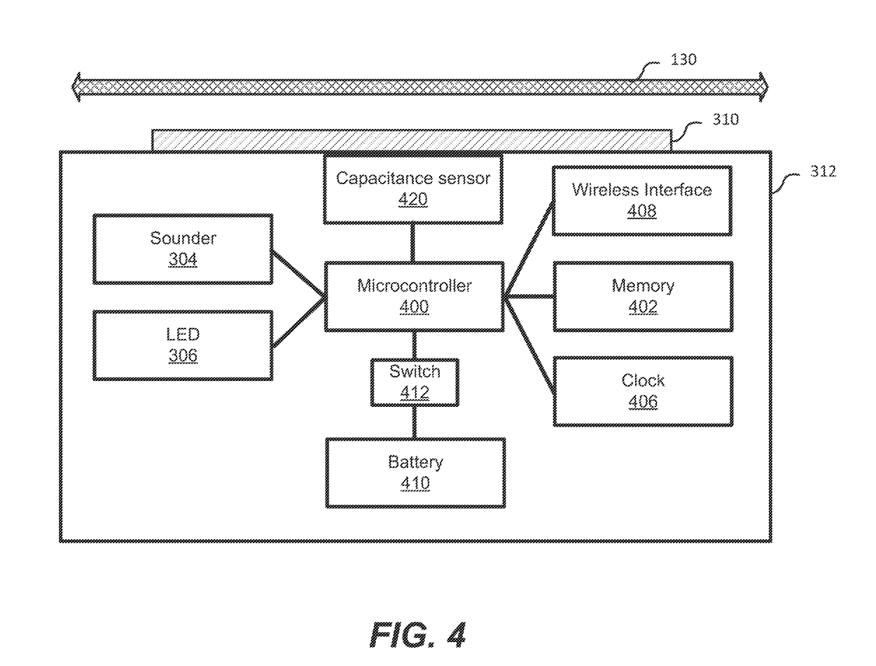

As show in FIG. 4, the controller 312 of the live powerline simulation system 100 has a microcontroller 400 for sensing capacitive changes and providing an alert. A memory 402 coupled to the microcontroller contains non-transitory computer readable instructions for operating the system. The microcontroller 400 may for example be a microcontroller such as the ATMega™ 328P. The memory may be integrated in the microcontroller 400 or provided by an external component. The instructions in the memory may provide calibration of the capacitive sensor, providing alerts when a contact is detected, provide instructions for tracking contacts and instructions for displaying or communicating alerts and/or statistics to a supervisory system. A power source such as a battery 410 powers the microcontroller 400 and associated components which can be decoupled by a power switch 412. A clock 406 provides a timing source for the microcontroller 400. The microcontroller 400 is coupled to an audible or visual indictor such as a piezo sounder 304 or speaker and/or a light emitting diode (LED) 306 or display. The microcontroller 400 is coupled to, or provides, a capacitance sensor 420 which contacts the mesh 310. The capacitance of the mesh 310 changes when it comes into contact with the powerline wire 130 or a conductive object. The controller 312 may also provide a wireless interface 408 for communicating with other devices, such as a smartphone, through a wireless interface 408 such as Bluetooth™, Zigbee™ or Wi-Fi™. A display on the controller 312 may also be provided to indicate the contacts and calibration information. The components are mounted on a PCB which can have a conductive bottom surface which can be exposed on the back of the controller 312 to directly interface with the mesh 310. Alternatively, the back of the controller 312 may have a conductive surface separate from the PCB which connects to the microcontroller 400 or can be coupled by a jumper wire. In order to capture stable measurements, the controller 312 features a virtual ground circuitry that provides a common reference point for the circuit without relying solely on the traditional grounding or bonding techniques. By not using a direct attachment to physical ground, the system allows the sensor to operate without the restricted range and maneuverability. Furthermore, since the system does not rely on a bonding technique, the system does not need to discharge the bonding material to provide more consistent results which, in conjunction with the virtual ground, eliminates noise and the need to periodically ground the sensor during use.

In an embodiment of the ATMega™ 328P or similar microcontroller or processor, the capacitive sensor can be implemented by the receive pin, which is a digital pin which is programmed to match the value of the send pin in order to time how long it takes to match the state of the send pin. The sensor works through the send and receive pins which ultimately are the ones responsible for measuring capacitance. The send pin is a digital pin which is programmed to change Boolean states when its state is matched by the receive pin. A 10kΩ resistor is a resolution resistor that determines the accuracy of the readings. The sensor implementation will vary based upon the microcontroller that is utilized or a dedicated ASIC, FPGA, or discrete component solution is implemented.

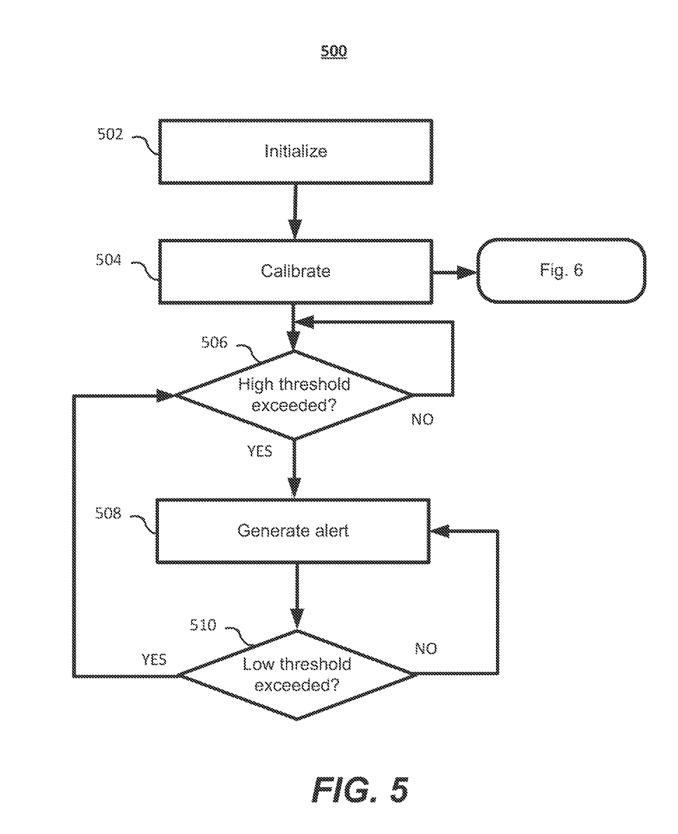

FIG. 5 shows a method of operation of an electrical powerline simulation system. The method 500 commences with power being turned-on the controller 312 to initialize (502) and commence start-up. The controller 312 enters a calibration phase (504), as further described in connection with FIG. 5, where the thresholds for high and low capacitance are determined. After the calibration phase the capacitance is measured by the capacitance sensor 420. If the capacitance is over the high threshold (YES at 506) an alert is generated (508). The alert may be an audible alert and/or visual alert. If the controller 312 is wirelessly enabled a message may be sent to a supervisory device to identify that a contact has occurred. The alert may continue while the threshold is exceeded (NO at 510) or until the low threshold is met. Once the measured capacitance is below the lower threshold (YES at 510) the alert is stopped and monitoring continues. A notification may be sent to a supervisory device of the contact, or a count of the number of contacts that have been made may be provided or displayed on the controller 312.

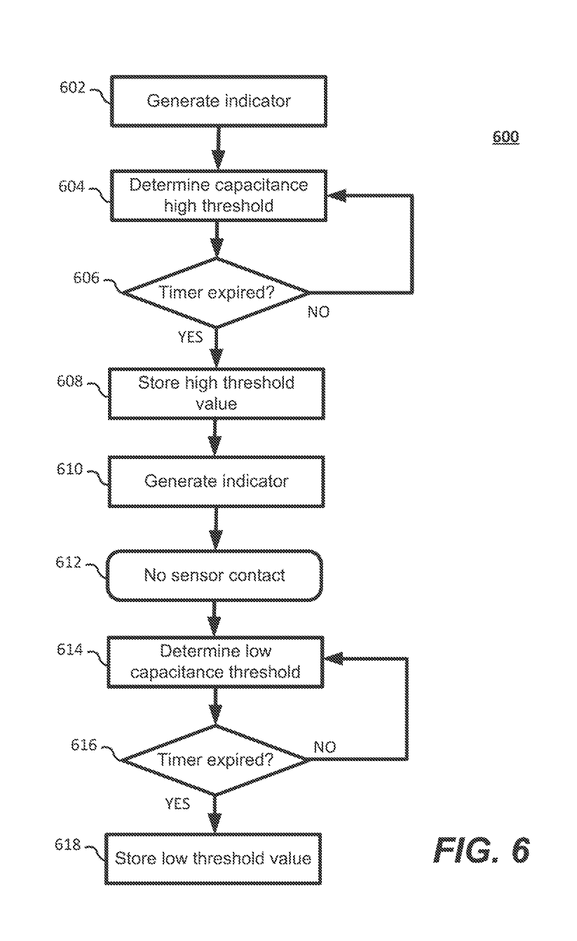

FIG. 6 show a method of calibrating a live electrical powerline simulation system. The calibration method 600 is utilized to determine thresholds for detecting contacts with the live electrical line simulation system 100. An indicator is generated to alert the technician to make contact (602) with controller 312 or mesh 310 to increase capacitance to identify a trigger signal (604). The alert may be a sound or an indicator on the controller 312 which alerts for a period of time such as 6 seconds. Once the timer has expired (YES at 606) a high threshold capacitance value is stored (608). The indicator may stop, a second indicator is generated, to alert the technician to cease contact (612). A low capacitance threshold (614) can then be determined. Once a timer has expired to detect the lower capacitance threshold (YES at 616), the indicator may then stop, or another indicator may be generated, and a low threshold value is stored (618). The controller 312 can then enter an operational mode and provide alerts when the capacity exceeds a threshold.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the system and method described herein may be provided by various combinations of software, firmware and/or hardware, other than the specific implementations described herein as illustrative examples.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Some embodiments are directed to a computer program product comprising a computer-readable medium or memory comprising code for causing a processor, or multiple processor, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a non-transitory computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the system, methods and apparatus of the various embodiments described above will be apparent to those skilled in the art in view of the above description. Such variations are to be considered within the scope.

1. A live electrical line simulation system comprising:
a conductive mesh liner for covering an exterior of a torso and arms of an electrical safety jacket worn by a powerline technician or trainee; and
a controller coupled to the mesh for detecting contact of the mesh with an un-energized electrical line, the contact detected through a change in capacitance of the mesh and providing an audible indication of the contact to the powerline technician or trainee.

2. The system of claim 1 wherein the controller comprises a microcontroller on a PCB board.

3. The system of claim 2 wherein the PCB board has a conductive back surface which contacts the conductive mesh liner.

4. The system of claim 3 wherein the controller has a virtual ground for the microcontroller.

5. The system of claim 2 wherein the PCB board is coupled to a conductive surface which contacts the conductive mesh liner.

6. The system of claim 5 wherein the microcontroller utilizes a sensor input to determine a capacitance state of the conductive surface.

7. The system of claim 2 wherein the PCB board is connected by a jumper to the conductive mesh liner.

8. The system of claim 2 wherein the controller further comprises a piezo sounder.

9. The system of claim 1 wherein the controller further comprises a light emitting diode.

10. The system of claim 1 wherein the mesh is a conductive material selected from the group comprising a copper, nickel/coper, silver plated, and copper-tin mesh.

11. The system of claim 1 wherein the mesh is a conductive copper-tin mesh.

12. The system of claim 1 wherein the controller further comprises a power source.

13. The system of claim 1 wherein the controller is calibrated to determine a capacitance state on start-up.

14. The system of claim 13 where the controller determines a high capacitance threshold and a low capacitance threshold to determine a change in capacitance.

15. The system of claim 1 wherein the controller is attached to the mesh or jacket by straps, clips or Velcro.

16. The system of claim 1 wherein the conductive mesh attaches by a plurality of snaps to the jacket.

17. The system of claim 1 wherein the conductive mesh is sewn to the jacket.

18. The system of claim 1 wherein the controller further comprises a wireless interface for communicating to touch contact to a supervisory computing device.

19. The system of claim 1 wherein a sensor is provided by a receive pin of the microcontroller, which is a digital pin programmed to match a value of a send pin in order to time how long it takes to match a state of the send pin.

20. The system of claim 19 further comprising a 10kΩ resolution resistor between the receive pin and the send pin.

21. A method of live electrical line simulation system, the method comprising:
detecting a higher capacitance threshold at a controller coupled to a conductive mesh liner covering an electrical safety jacket, when the conductive mesh is in contact with an object;
detecting a lower capacitance threshold at the controller when the conductive mesh is not contacting the object;
detecting by the controller when a determined capacitance is above the higher capacitance threshold; and
generating an alert while the determined capacitance is above the higher capacitance threshold and terminating the alert when the determined capacitance is at a lower capacitance threshold.

22. An electrical line safety jacket comprising:
a conductive mesh on the exterior of the safety jacket on a torso and arms of an electrical safety jacket worn by a powerline technician or trainee; and
a controller coupled to the mesh for detecting contact of the mesh with an un-energized electrical line, the contact detected through a change in capacitance of the mesh and providing an audible indication of the contact to the powerline technician or trainee.
